(19) United States
(12) Patent Application Publication
(10) Pub. No.: US 2020/0021471 A1
(43) Pub. Date: Jan. 16, 2020

(54) METHOD FOR CORRECTING AN IMPULSE RESPONSE OF A MULTIPATH PROPAGATION CHANNEL, CORRESPONDING COMPUTER PROGRAM AND DEVICE

(71) Applicant: ENENSYS TECHNOLOGIES, Cesson-Sevigne (FR)

(72) Inventors: Frederic Mosset, Rennes (FR); Frederic Pirot, Sens De Bretagne (FR)

(21) Appl. No.: 16/513,074

(22) Filed: Jul. 16, 2019

(30) Foreign Application Priority Data
Jul. 16, 2018 (FR) 1856550

(51) Int. Cl. H04L 27/00; H04L 25/02; H04B 17/30

(52) U.S. Cl. CPC H04L 27/0014; H04L 25/0212; H04L 2027/0026; H04B 17/30; H04L 25/0204

(57) ABSTRACT

A method for correction of an impulse response of a multipath propagation channel. Such a method includes at least one iteration of the following acts: obtaining a current impulse response of the propagation channel; estimating a temporal shift between the current impulse response and a reference impulse response of the propagation channel; and correcting the current impulse response based on at least the temporal shift, delivering a corrected impulse response.

### 1 TECHNICAL FIELD

The field of the invention is the implementation of information propagation through a propagation channel that can have multiple paths (or echoes).

The invention relates most particularly to monitoring of propagation conditions through such a propagation channel.

The invention has many applications, particularly but not exclusively in the field of broadcasting networks, for example digital video broadcasting networks (particularly according to the DVB-T/T2 (Digital Video Broadcasting—Terrestrial), ISDB-T Integrated Services Digital Broadcasting—Terrestrial), ATSC-3 (Advanced Television Systems Committee) standards, etc.) or digital audio broadcasting networks (particularly according to the DAB standard.

### 2 TECHNOLOGICAL BACKGROUND

The remainder of this document is particularly concerned with a problem that exists in the field of monitoring of the propagation channel used in digital video broadcasting networks, and particularly in an SFN (Single Frequency Network), faced by the inventors of this patent application. Obviously, the invention is not limited to this particular field of application, but is useful for monitoring any propagation channel with multiple paths (e.g. acoustic, optical transmission, etc.).

The Channel Impulse Response (CIR) of a radioelectric propagation channel is the response of the propagation channel in question to an impulse waveform transmitted by a transmitter at a given instant. Such an impulse is received directly and may also be received in the form of replicas by a receiver after a propagation time in the channel concerned.

For example, if the propagation channel is of the single-path type (e.g. when the transmitter and the receiver are in direct line of sight), an impulse emitted by the transmitter generates a single impulse received by the receiver. On the other hand, if the propagation channel is of the multipath type (e.g. via reflections on surrounding objects), a transmitted impulse will generate a stream of impulses received by the receiver.

Moreover, in an SFN network in which several transmitters transmit the same data at the same time and at the same frequency, the same phenomenon is observed at a receiver placed in a coverage zone of each of the transmitters concerned.

Finally, there can be multiple paths within an SFN network, which results in even more complex CIRs as illustrated on FIGS. 1a and 1b.

More particularly, terminal 100 in FIG. 1a receives an impulse emitted simultaneously at time t0 by the first 110a and second 110b transmitters three times, through three distinct paths 120a, 120b and 120c.

As a result, the CIR obtained (FIG. 1b) at the terminal 100 includes:
at time t1, a first peak 150a corresponding to the first path 120a in direct line of sight between the second transmitter 110b and the terminal 100. The first path 120a is the shortest among the three paths 120a, 120b and 120c;
at time t2, a second peak 150b corresponding to the second path 120b between the second transmitter 110b and the terminal 100 via a reflection on building 130; and
at time t3, a third peak 150c corresponding to the third path 120c in direct line of sight between the first transmitter 110a and the terminal 100, the third path 120c being the longest among the three paths 120a, 120b and 120c.

Monitoring equipment can be used to monitor the received CIR at a given point, in order to manage an SFN type network. Alarms for the presence of some paths can then be installed, to make sure that the different network transmitters are still transmitting.

A first problem related to such a monitoring system originates from the fact that the CIR is not necessarily fixed in time. For example, in the case illustrated on FIG. 1a, if the second path 120b is provoked by reflection on a truck parked in a parking area and not on the building 130, the CIR will change when the truck drives away.

A second problem related to such a monitoring system originates from the fact that the CIR is obtained after demodulation by the receiver of the monitoring device. Such demodulators will attempt to position the CIR within a predefined observation time window, that is optimum in terms of demodulation and decoding.

For example, some demodulators will put the CIR in the observation window concerned based on the weighted centre of gravity of the different CIR peaks (each peak corresponding to a given path in the propagation channel). Such a behaviour is illustrated on the three CIRs in FIGS. 2a to 2c, each corresponding to the same channel considered at three different instants. Thus, three CIRs are obtained with peaks positioned differently in the observation window as a function particularly of the power of the peaks concerned (and therefore equivalently, on the attenuation that occurs on the signal along the corresponding path). It is thus observed that there is a strong chance that a given path will change its temporal position in the observation window due to the change in the power and delay of the different paths of the propagation channel. As a result, a monitoring instrument for which an alert is set on a given path (e.g. located in the middle of the window) at a given instant has a good chance of triggering a false alarm when the monitored path moves in time in the observation window. This behaviour is also amplified when the demodulator positions the CIR in the window based on the strongest path. In this case, the sudden change from one path to another can occur when the highest power path changes at a given moment.

There is thus a need to stabilise the CIR, for example in order to minimise false alerts from monitoring equipment.

Finally, there is a need for the proposed method to be simple in terms of the hardware implementation.

### SUMMARY

Thus, according to a first aspect, the invention relates to a method for correcting an impulse response of a multipath propagation channel. Such a method comprises at least one iteration of the following steps:
obtaining a current impulse response of the propagation channel;
estimating a temporal shift between the current impulse response and a reference impulse response of the propagation channel; and
correcting the current impulse response based on at least the temporal shift, delivering a corrected impulse response.

Thus, the invention discloses a new and inventive solution to correct a multipath propagation channel impulse response (CIR), e.g. a radio frequency propagation channel.

To achieve this, the claimed method proposes to estimate temporal shifts of the CIR concerned (in other words the temporal shift of the temporal support of the CIR) in order to correct it. The CIR is thus stabilised. For example, peaks representative of multiple paths of the propagation channel remain at the same temporal position regardless of the temporal drifts of the CIR over time.

According to one particular embodiment, the estimating a temporal shift includes a calculation of a correlation function between the current impulse response and the reference impulse response. The temporal shift is a function of an extremal value of the correlation function.

Thus, the estimate of the temporal shift is precise.

According to one particular embodiment, the estimating a temporal shift comprises the following sub-steps for at least two peaks in the current impulse response, each corresponding to a path in the propagation channel:
determining a candidate delay between one of the peaks and a peak of the same rank in the reference impulse response;
setting up temporal concordance of the current impulse response with the reference impulse response based on the candidate delay;
comparing the current impulse response with the reference impulse response after setting up temporal concordance based on the candidate delay, the comparing delivering a relevance score associated with the candidate delay. The temporal shift is a function of the candidate delay associated with the extremal relevance score.

For example, such an estimate can be used to manage CIR configurations in which the use of a correlation can be less reliable, particularly in the case in which here is no variation of temporal positioning of CIR peaks, but a relative variation of the power of the peaks concerned.

According to one particular embodiment, the relevance score is a function of the number of peaks in the current impulse response superposing on a peak corresponding to the reference impulse response after setting up temporal concordance based on the candidate delay.

According to one particular embodiment, if the absolute value of the extremal relevance score is less than a predetermined minimum score, the estimate of a temporal shift also includes a calculation of a correlation function between the current impulse response and the reference impulse response. The temporal shift is a function of an extremal value of the correlation function instead of the candidate delay associated with an extremal relevance score.

Thus, the two complementary methods (i.e. the method based on setting up temporal concordance and the method based on calculating a correlation function) are each used when they give the best results, so that the reliability of the estimate obtained can thus be maximised.

According to one particular embodiment, the correlation function is calculated in the frequency domain.

According to one particular embodiment, the method also includes a step for estimating at least one absolute level of a current peak of the current impulse response. The correcting the current impulse response is also based on said at least one absolute level.

Thus, the level (e.g. the amplitude or power) of the peaks present in the CIR is also corrected in addition to the temporal drifts. For example, when the CIR concerned is obtained at the output from the demodulator of a receiver, a compensation is obtained by level variations introduced by a combination of effects of the AGC (Automatic Gain Control) system and effects of the demodulator when it is temporally stuck on a higher-level path.

According to one particular embodiment, the estimating the absolute value of the current peak includes the following sub-steps:
setting up temporal concordance of the current impulse response with the reference impulse response based on the temporal shift;
determining a level difference between the current peak and at least one peak of the reference impulse response temporally adjacent to the current peak after setting up temporal concordance based on the temporal shift;
obtaining a change in a signal level that has propagated through the propagation channel when the propagation channel passes from:
   a reference state corresponding to the reference impulse response, to
   a state corresponding to the current impulse response.
      The absolute level of the current peak is a function of at least the difference in level and the change in the signal level.

According to one particular embodiment, the step of obtaining comprises elimination of peaks with an absolute level less than a predetermined threshold in a primary impulse response of the propagation channel delivering the current impulse response.

Thus, only paths of interest are processed.

According to one particular embodiment, for a current iteration, the reference impulse response is a corrected impulse response obtained in a preceding iteration.

According to one particular embodiment, for a current iteration, the reference impulse response is an impulse response of the propagation channel selected at a given instant.

According to one particular embodiment, the method also comprises a step to display the corrected impulse response on a screen of propagation channel monitoring equipment.

The invention also relates to a computer program comprising program code instructions for executing the steps of the method for correcting an impulse response of a multipath propagation channel as described above.

The invention also relates to a device for correcting an impulse response of a multipath propagation channel able to implement the method of correcting an impulse response of a multipath propagation channel according to the invention (according to any one of the different embodiments mentioned above).

Thus, the characteristics and advantages of this device are the same as those for the method of correcting an impulse response of a multipath propagation channel described above. Consequently, they are not described in further detail.

### 4 LIST OF FIGURES

Other characteristics and advantages of the invention will become clear after reading the following description, given as a simple illustrative and non-limitative example, and the appended drawings among which:

FIGS. 1a and 1b, already discussed above in section 2, illustrate a terminal receiving a signal through three paths in an SFN network and the corresponding CIR, respectively;

FIGS. 2a, 2b and 2c, already discussed above in section 2, illustrate three CIRs each corresponding to the same channel considered at three different instants;

FIG. 3a illustrates the steps of a method for correcting a CIR according to one embodiment of this invention;

FIG. 3b illustrates the steps of a method for correcting a CIR according to another embodiment of this invention;

FIGS. 3c and 3d give details of sub-steps E310 and E320 respectively of the method in FIG. 3b according to one embodiment of the invention;

FIG. 4 illustrates an example of the calculation of a delay like that used in a sub-step of step E310 of the method in FIG. 3b;

FIGS. 5a and 5b illustrate a problem encountered during implementation of step E320 of the method in FIG. 3b;

FIG. 6 illustrates function blocks of a device for correcting a CIR according to one embodiment of the invention.

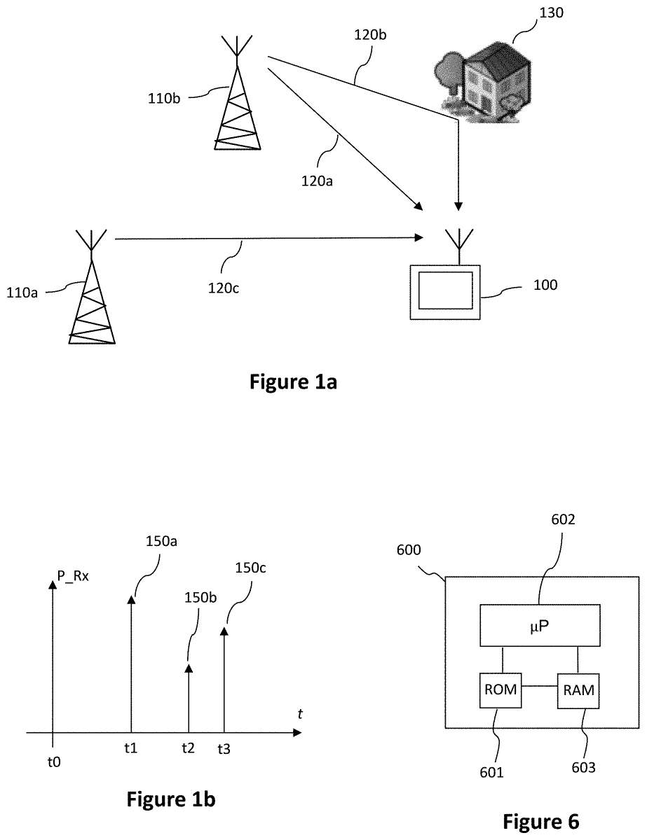

### 5 DETAILED DESCRIPTION OF THE INVENTION

Identical elements and steps are designated by the same reference signs in all figures in this document.

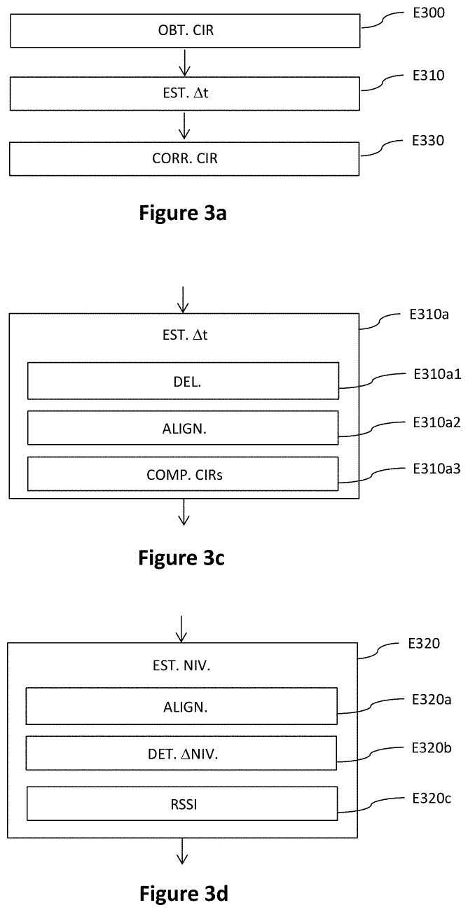

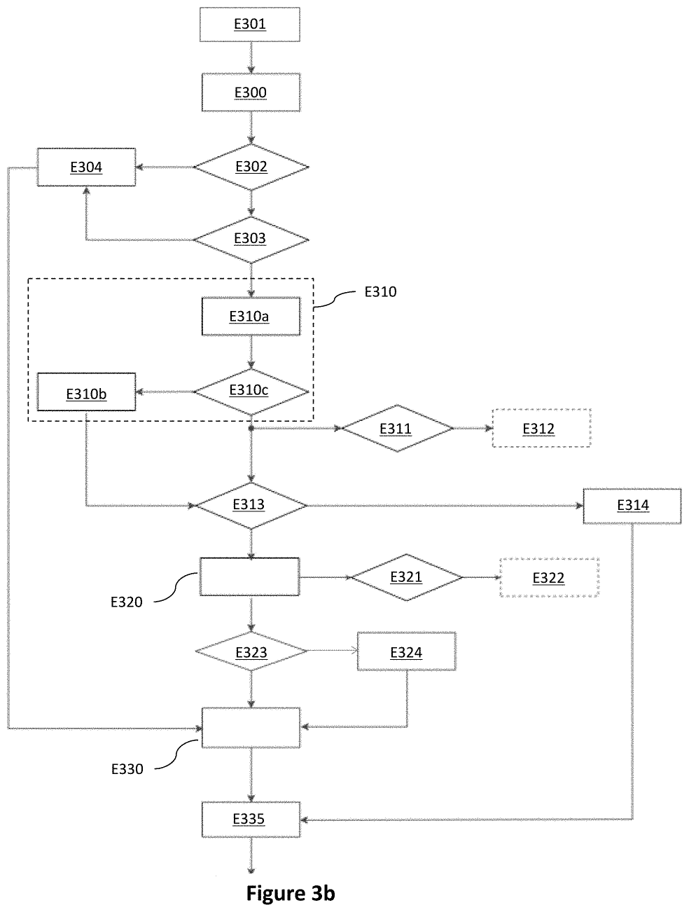

We will now describe the main steps of a method for correcting a CIR using an embodiment of the invention representative of the general principal of the invention, with reference to FIG. 3a.

During a step E300, a current CIR of a multipath channel (e.g. a radio frequency, acoustic, propagation channel, etc.) is obtained. Such a CIR represents the response of the propagation channel to an impulse wave shape transmitted by at least one transmitter at a given time.

During a step E310, a temporal shift between the current CIR obtained during step E300 and a reference CIR of the propagation channel is estimated. In this case, temporal shift means the shift in time between temporal supports of the current CIR and the reference CIR. For example, the reference CIR is an impulse response of the propagation channel selected at a given instant (i.e. an “initial” reference CIR).

During a step E330, the current CIR is corrected based on the temporal shift estimated during implementation of step E300. A corrected CIR is then delivered.

It will be noted that these different steps can be implemented in the form of at least one iteration.

Thus, the CIR of the propagation channel is stabilised. For example, peaks representative of multiple paths of the propagation channel remain at the same temporal position regardless of the temporal drifts of the CIR over time.

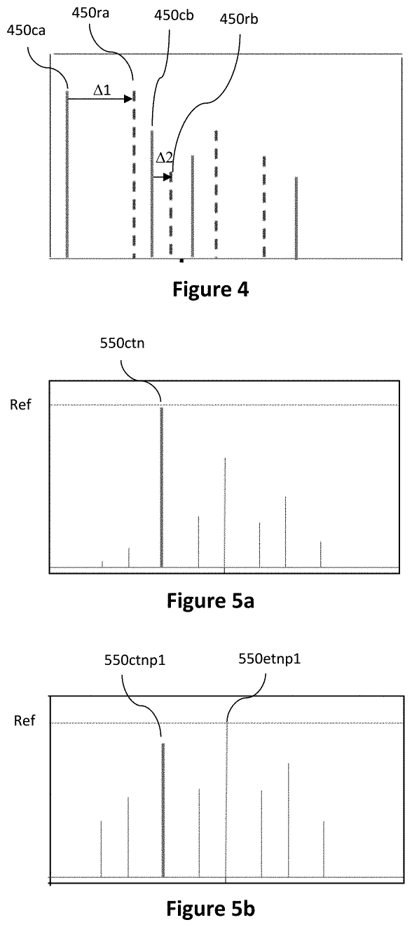

We will now describe the main steps of the method for correcting a CIR according to different embodiments of the invention, with reference to FIGS. 3b, 3c and 3d. Some processing used in some steps of the method according to the invention is also discussed with reference to FIGS. 4, 5a and 5b.

More particularly, during a step E301, a primary CIR of the propagation channel is obtained. For example, such a primary CIR is delivered by a demodulator of a receiver of equipment for monitoring an SFN network.

During step E300 for obtaining the current CIR, the peaks of the primary CIR with an absolute level less than a predetermined threshold can thus be deleted.

Thus, the CIR is shaped such that only peaks corresponding to paths of interest, also called significant echoes, in the propagation channel are kept in the current CIR.

In other embodiments not illustrated, step E301 is not implemented and the current CIR includes all peaks representative of all paths of the propagation channel.

In some embodiments, the primary CIR and/or the current CIR and/or the reference CIR are obtained from a signal that has propagated through the propagation channel. For example, this may be an OFDM (Orthogonal Frequency-Division Multiplexing) modulated signal as used in digital broadcasting networks (e.g. DVB-T/T2, ISDB-T, ATSC-3, DAB, etc.). In some embodiments, the signal concerned was captured via a single antenna, as is classically the case for SFN network monitoring equipment.

Back to FIG. 3b, eligibility of the current CIR for the method for correcting according to the invention is tested during a step E302.

For example, the number of peaks present in the current CIR is counted. If this number is less than a minimum number (e.g. the minimum number is chosen to be equal to 3), the method according to the invention is not used. Similarly, if this number is more than a maximum number (e.g. the maximum number is chosen to be equal to 64), the method according to the invention is not used to avoid a calculation overload.

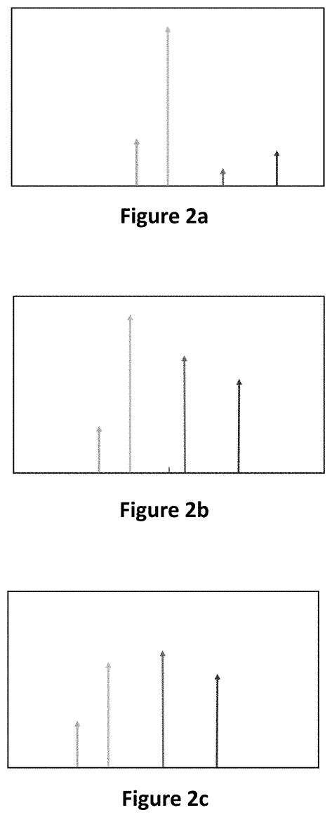

When it is decided that the current CIR is not eligible for the correction method according to the invention, a known method of repositioning in a predefined temporal window is applied to the current CIR during a step E304. For example, it could be a known method based on the weighted centre of gravity of the different peaks of the CIR based on the strongest path as described above with reference to FIGS. 2a to 2c. In this case, the parameters obtained using such a known method are used during step E330 to correct the current CIR.

In other embodiments not illustrated, step E302 is not used and the current CIR is systematically processed using the correction method according to the invention.

Back to FIG. 3b, during a step E303, it is checked that the enforcement of the method for correcting according to the invention is authorised independently of the characteristics of the current CIR. For example, the enforcement may be suspended in order to save calculation resources of the system performing the processing. In this case, the current CIR is processed using a known method in step E304 even though it was recognised as being eligible in step E302.

In other embodiments not illustrated, step E303 is not used and the current CIR is systematically processed using the correction method according to the invention.

In the embodiment illustrated on FIG. 3b, the temporal shift between the current CIR and the reference CIR is estimated in the estimating step E310. For example, such a temporal shift is estimated using steps E310a, E310b and E310c.

According to one example embodiment, during step E310a, the temporal shift between the current CIR and the reference CIR is estimated by setting a temporal concordance of the current CIR and the reference CIR in question. Furthermore, the temporal shift thus estimated is associated with a relevance score.

For example, as illustrated on FIG. 3c, step E310a comprises a step E310a1 during which a candidate delay between peaks of the current CIR and a peak with the same rank in the reference CIR is determined. Moreover, during a step E310a2, the current CIR and the reference CIR are put into temporal concordance based on the candidate delay. For example, the current CIR or the reference CIR is temporally shifted so as to tend towards superposition of the current CIR and the reference CIR. In this way, during a step E310a3, the current CIR and the reference CIR are compared after putting into temporal concordance so as to deliver a performance score associated with the candidate delay. For example, the relevance score is a function of the number of peaks in the current CIR superposing on a peak corresponding to the reference CIR after setting up temporal concordance mentioned above based on the candidate delay. Furthermore, when steps E310a, E310b and E310c (described below) are enforced for at least two peaks of the reference CIR, the temporal shift is chosen as being the candidate delay associated with the extremal relevance score (e.g. the highest relevance score). This estimate of the temporal shift requires a small calculation load.

The processing associated with steps E310a, E310b and E310c can be better understood, for example by considering the configuration illustrated on FIG. 4. More particularly, the rank 1 peak 450ca of the current CIR (composed of peaks in solid lines) is located at a candidate delay Δ1 of the rank 1 peak 450ra of the reference CIR (composed of peaks in discontinuous lines). In this way, during step E310a2, the current CIR, or the reference CIR, is temporally shifted by the candidate delay Δ1 in an attempt to superpose the current and reference CIRs, or at least rank 1 peaks 450ca and 450ra. During step E310a3, a relevance score associated with the candidate delay Δ1 is obtained as being the number of peaks of the current CIR superposed on the corresponding peak of the reference CIR after the temporal shift of the current CIR or the reference CIR. Steps E310a, E310b and E310c are then applied successively to other peaks of the current CIR. For example steps E310a, E310b and E310c are applied to the rank 2 peak 450cb located at a candidate delay Δ2 of the rank 2 peak 450rb of the reference CIR. A relevance score associated with the candidate delay Δ2 is obtained and the temporal shift is chosen as being the candidate delay associated with the highest relevance score.

Back to FIG. 3b, during a step E310c, the relevance score associated with the temporal shift estimated in step E310a is compared with a threshold. For example, if the relevance score in question is less than a predetermined minimum score, the temporal shift thus estimated by application of step E310a is no longer used because it is not considered to be sufficiently reliable.

In this case, the temporal shift is estimated once again during a step E310b by calculating a correlation function between the current CIR and the reference CIR. Thus, the most appropriate method of estimating the temporal shift is used, depending on the situation. Furthermore, the global calculation load of the proposed method remains under control.

In some variants, such a correlation function is calculated in the temporal domain using a sliding window. More particularly, the reference CIR is temporally shifted by a value n*Ts, where Ts is a sampling period and n varies by one unit during each iteration, before being multiplied temporal sample by temporal sample with the current CIR. The sum of the product of coincident points between these 2 CIRs then gives a value of the correlation function for the temporal value n*Ts considered. Such a direct calculation in the temporal domain can be interpreted as a convolution between CIRs.

Alternatively, in other variants, the correlation function is calculated in the frequency domain. In this case, the convolution encountered in the temporal domain is transformed into a simple term-by-term multiplication in the frequency domain, thereby simplifying implementation of the solution. This approach is based on the calculation of the Fourier transform (e.g. in the form of a DFT (Discrete Fourier Transform) or FFT (Fast Fourier Transform) of current and reference CIRs, and the inverse Fourier transform of the result of the term by term multiplication in question.

In embodiments not illustrated, steps E310c and E310b are not implemented and the temporal shift is still estimated by applying temporal concordance of current and reference CIRs through step E310a, for example to manage CIR configurations in which the use of a correlation may be less reliable.

In embodiments not illustrated, steps E310a and E310c are not used and the temporal offset is still estimated by correlation through the use of step E310b.

Back to FIG. 3b, during a step E311, the reference CIR may be compared with an initial reference CIR. In this way, if it is decided that the reference CIR is sufficiently close to an initial reference CIR, the reference CIR is reinitialised to the value of the initial reference CIR during a step E312 for a new application of steps in the method according to the invention to a new current CIR.

During a step E313, it is decided if the temporal shift estimated in step E310 is coherent (e.g. it is decided if step E310 has not produced an aberrant value or no value at all, etc.). If it is decided that the temporal shift estimated in step E310 is not coherent, the temporal shift estimated during application of this step E310 is not kept during a step E314 and the current CIR is delivered as is during a step E335, i.e. without correction based on the temporal shift.

On the contrary, if it is decided that the temporal shift estimated in step E310 is coherent, one or several absolute levels of one or several corresponding peaks of the current CIR is or are estimated in a step E320. Thus, the level (e.g. the amplitude or power) of peaks present in the CIR is also corrected in addition to the temporal drift.

For example, in the embodiment illustrated on FIG. 3d, step E320 comprises a step E320a during which the current CIR and the reference CIR are put into temporal concordance based on the temporal shift estimated during step E310. For example, the current CIR or the reference CIR is temporally shifted by a delay equal to the temporal shift. During a step E320b, a level difference is determined between a current peak of the current CIR and at least one peak of the reference CIR temporally close to the current peak after setting up temporal concordance based on the temporal shift. In this way, the relative change in the level of the current peak considered between the time corresponding to the current CIR and the time corresponding to the reference CIR is obtained. However, in the considered embodiment, during a step E320c, a change is also obtained in the level of a signal that has been propagated through the propagation channel when the propagation channel passes from:
a reference state corresponding to the reference CIR, to
a state corresponding to the current CIR.

For example, the change in question is obtained by means of an RSSI (Received Signal Strength Indication) delivered by the demodulator of the monitoring equipment currently monitoring the propagation channel in question. Knowledge of such a change to the absolute value of the total signal that passed through the channel can be useful for example when the current CIR and/or the reference CIR were delivered by demodulators hosting some gain control functions in the reception system, namely the AGC (Automatic Gain Control).

FIGS. 5a and 5b illustrate a problem associated with such an AGC system. More particularly, rank 3 peak 550ctn in the CIR considered at time N (FIG. 5a) is the highest peak in the CIR in question. Thus, the AGC of the receiver of the monitoring system that delivers the CIR in question determines system gains such that the received signal level (in this case determined by the level of the predominant peak 550ctn) reaches the Ref. set level. However at time N+1 (FIG. 5b), the level of rank 3 peak 550ctnp1 in the CIR now considered at time N+1 has dropped such that the peak in question is no longer the predominant peak in the received signal level. As a result, assuming that the absolute value of peaks other than peak 550ctnp1 has not changed between times N and N+1, the AGC will increase reception gains such that the received signal level (level determined in this case by the level of rank 5 peak 550etnp1 that is the predominant peak) still reaches the Ref. set level. Thus, based simply on the CIR as delivered by the demodulator after application of AGC gains, it appears a priori that the level of all peaks present in the CIR has changed between times N and N+1 although an analysis based on knowledge of the change in the received signal level (i.e. in the power of all peaks present in the CIR in practice) makes it possible to make a distinction between firstly variations in the level of the peaks themselves and secondly the effect of the AGC.

However, in other embodiments not illustrated, step E320c is not used and only changes in the level of peaks are determined in step E320b, for example when no AGC system is present.

In yet other embodiments not illustrated, step E320 to estimate the absolute level of peaks in the current CIR is not implemented and the correction in step E330 is based only on the temporal shift estimated in step E310.

With reference once again to FIG. 3b, in a step E321 the current CIR is compared with the reference CIR, particularly concerning the power of peaks making up the CIRs in question. In this way, if it is decided that the current CIR is too far from the reference CIR, the reference CIR is reinitialised during a step E322 to the value of the current CIR, after correcting this current value, for another application of the steps mentioned above in the method according to the invention. In other words, for a given iteration of the method, the reference impulse response is a corrected impulse response obtained in a preceding iteration (i.e. an “iterative” reference CIR).

During a step E323, it is decided if the absolute level of peaks of the current CIR estimated in step E320 is coherent (e.g. it is decided if step E320 has not produced aberrant values or no value at all, etc.). If it is decided that the level in question is not coherent, the level thus estimated is not kept and the global level of the CIR is corrected during a step E324. In this case, the absolute level of peaks in the current CIR estimated in step E320 is not used during correction of the CIR in step E330. On the contrary, when it is decided that the absolute level of peaks of the current CIR estimated in step E320 is coherent, the correction of the CIR in step E330 takes account of the absolute value of peaks in the current CIR estimated in step E320.

During step E335, the CIR corrected during step E330 (based on the temporal shift estimated during application of step E310 and possibly based on absolute level(s) estimated during application of step E323) is shaped to be delivered, for example, to a display device or to a device for monitoring the propagation channel, etc. In some embodiments, the method also comprises a step to display the corrected CIR, for example on a screen of the display device or the propagation channel monitoring equipment, etc. More particularly, a CIR is classically displayed on a graph with time and power axes. However, for a CIR that has not been corrected using this technique, the display is made for example by adjusting the highest power echo to the point with coordinates (0 μs, 0 dB). In other words, all echoes are displayed relative to the most powerful echo (main echo). On the contrary, a CIR corrected using this technique is stable in time and also in level depending on the embodiment considered. In this way, a CIR corrected using this technique can be displayed keeping the temporal positions and absolute power levels, i.e. as delivered during step E335.

In some embodiments, the method also comprises a step of monitoring at least one peak in the corrected OR, said monitoring comprising triggering an alarm in case a level of said at least one peak goes outside a predetermined range of levels. The alarm can include a graphic displayed on the display screen, an audible alarm, generation of a message for transmission through a network, etc. for example.

Furthermore if, as described above, it is decided during application of step E313 that the temporal shift estimated in step E310 is not coherent, the current CIR is delivered as is during step E335, i.e. without correction in step E330.

FIG. 6 presents an example of the structure of a device 600 for correcting a CIR. More particularly, such a device 600 can be used to implement the method in FIGS. 3a to 3d. The device 600 comprises a volatile memory 603 (for example a RAM memory), a processing unit 602 equipped for example with a processor and controlled by a computer program stored in non-volatile memory 601 (for example ROM memory or a hard disk). On initialisation, instructions in the computer program code are for example loaded in the volatile memory 603 before being executed by the processor of the processing unit 602.

This FIG. 6 illustrates only one particular way among several possible ways of making means contained in the device 600 so that it performs some steps in the method described above with reference to FIGS. 3a to 3d (in any one of the different embodiments). These steps can indifferently be performed on a reprogrammable computation machine (a PC computer, a DSP processor or a microcontroller) running a program comprising an instruction sequence, or on a dedicated computation machine (for example a set of logical gates such as an FPGA or an ASIC, or any other hardware module). In the case in which the means included in the device 600 are made with a reprogrammable computation machine, the corresponding program (in other words the instruction sequence) can be stored on a removable storage medium (for example such as a diskette, a CD-ROM or a DVD-ROM) or a non-removable storage medium, this storage medium being partially or completely legible by a computer or processor.

1. A method for correcting an impulse response of a multipath propagation channel, wherein the method comprises at least one iteration of the following acts performed by a device:
obtaining a current impulse response of said propagation channel;
estimating a temporal shift between said current impulse response and a reference impulse response of said propagation channel; and
correcting said current impulse response based on at least said temporal shift, delivering a corrected impulse response.

2. The method according to claim 1,
wherein said estimating a temporal shift includes calculating a correlation function between said current impulse response and said reference impulse response,
said temporal shift being a function of an extremal value of said correlation function.

3. The method according to claim 1,
wherein the estimating of a temporal shift comprises the following sub-acts for at least two peaks in said current impulse response, each corresponding to a path in said propagation channel:
determining a candidate delay between one of said peaks and a peak of the same rank in said reference impulse response;
setting up temporal concordance of said current impulse response with said reference impulse response based on said candidate delay;
comparing said current impulse response with said reference impulse response after said setting up temporal concordance based on said candidate delay, said
comparing delivering a relevance score associated with said candidate delay, said temporal shift being a function of the candidate delay associated with the extremal relevance score.

4. The method according to claim 3,
wherein said relevance score is a function of the number of peaks in said current impulse response superposing on a corresponding peak in said reference impulse response after said setting up temporal concordance based on said candidate delay.

5. The method according to claim 3,
wherein, if the absolute value of said extremal relevance score is less than a predetermined minimum score, said estimating of a temporal shift also includes a calculation of a correlation function between said current impulse response and said reference impulse response, said temporal shift being a function of an extremal value of said correlation function instead of said candidate delay associated with an extremal relevance score.

6. The method according to claim 1, also including estimating at least one absolute level of a current peak of said current impulse response,
said correcting said current impulse response being also based on said at least one absolute level.

7. The method according to claim 6,
wherein said estimating the absolute value of said current peak includes the following sub-steps:
setting up temporal concordance of said current impulse response with said reference impulse response based on said temporal shift;
determining a level difference between said current peak and at least one peak of said reference impulse response temporally adjacent to said current peak after said setting up temporal concordance based on said temporal shift;
obtaining a change in a signal level that has propagated through said propagation channel when said propagation channel passes from:
a reference state corresponding to said reference impulse response, to
a state corresponding to said current impulse response;
said absolute level of said current peak depending on at least said level difference and said change in the signal level.

8. The method according to claim 1,
wherein said act of obtaining comprises eliminating peaks with an absolute level less than a predetermined threshold in a primary impulse response of said propagation channel delivering said current impulse response.

9. The method according to claim 1,
wherein, for a current iteration, said reference impulse response is a corrected impulse response obtained in a preceding iteration.

10. The method according to claim 1,
wherein, for a current iteration, said reference impulse response is an impulse response of said propagation channel selected at a given instant.

11. A non-transitory computer-readable medium comprising a computer program stored thereon comprising program code instructions for implementing a method of correcting an impulse response of a multipath propagation channel when said program is executed by a processor of a device, wherein the instructions configure the device to perform at least one iteration of the following acts:
obtaining a current impulse response of said propagation channel;
estimating a temporal shift between said current impulse response and a reference impulse response of said propagation channel; and
correcting said current impulse response based on at least said temporal shift, delivering a corrected impulse response.

12. A device for correcting an impulse response of a multipath propagation channel, wherein the device comprises:
a reprogrammable computation machine or a dedicated computation machine configured to:
obtain a current impulse response of said propagation channel;
estimate a temporal shift between said current impulse response and a
reference impulse response of said propagation channel; and
correct said current impulse response based on at least said temporal shift, delivering a corrected impulse response.

13. The method according to claim 1, further comprising at least one of:
delivering the corrected impulse response to a display device; or
displaying the corrected impulse response on a screen of the display device.

14. The non-transitory computer-readable medium according to claim 11, wherein the instructions configure the device to perform at least one of:
delivering the corrected impulse response to a display device; or
displaying the corrected impulse response on a screen of the display device.

15. The device according to claim 12, wherein the reprogrammable computation machine or dedicated computation machine is further configured to perform at least one of:
delivering the corrected impulse response to a display device; or
displaying the corrected impulse response on a screen of the display device.
